(19) United States
(12) Patent Application Publication
(10) Pub. No.: US 2010/0299191 A1
(43) Pub. Date: Nov. 25, 2010

(54) METHOD AND APPARATUS FOR THE TRANSMISSION OF MULTIMEDIA CONTENT

(75) Inventor: Alvaro Fernández Gutierrez, Barcelona (ES)

Correspondence Address: BERENBAUM WEINSHIENK PC, 370 17TH STREET, SUITE 4800, DENVER, CO, 80202, US

(73) Assignee: Media Patents, S.L., Barcelona (ES)

(21) Appl. No.: 12/512,866

(22) Filed: Jul. 30, 2009

(30) Foreign Application Priority Data
May 19, 2009 (ES) P200930184

(51) Int. Cl. H04L 12/66; G06Q 30/00

(52) U.S. Cl. 705/14.5; 370/352

(57) ABSTRACT

Method and apparatus to transmit over a data network, advertising content inserted in multimedia content associated with an event. In one embodiment, a server receives from a first network node connected to the data network, advertising content to be inserted in the multimedia content associated with an event that occurs at a specific time and place, and the server receives a message, by means of a first IP-based communications management protocol, in order to establish a real-time multimedia communication using IP packets with a second node of the data network, and the server establishes multimedia communication with the second network node, and the server receives from the second network node, multimedia content that includes geotagging data in the form of coordinates, and the server determines that this multimedia content is associated with the event from this geotagging data in the form of coordinates, and the server creates a multimedia file that contains the advertising content and at least one part of the multimedia content, and the server transmits at least one part of the multimedia file to a third network node.

### CROSS-REFERENCE TO RELATED APPLICATIONS

This application claims priority to Spanish Patent Application P200930184, filed May 19, 2009.

### TECHNICAL FIELD

The invention relates to multimedia data communication over a data network, such as the Internet.

### BACKGROUND

Different protocols exist for establishing and managing multimedia communications in data networks such as the Internet. The SIP, or Session Initiation Protocol, and the H.323 protocol are two examples of these types of protocol.

In recent years use of the SIP protocol has been extended due to the fact that it has become one of the most used VoIP (Voice over IP) communication protocols. The SIP protocol not only facilitates VoIP communications, but also multimedia communications such as video conferencing communications.

The SIP protocol is described in the RFC 3261 specifications published on-line by the IETF (J. Rosenbert et al. Internet Engineering Task Force, Network Working Group, Request for Comments 3261, June 2002; currently available at the Internet address www.ietf.org/rfc/rfc3261.txt).

FIGS. 1 and 2 briefly describe the operation of the SIP protocol.

FIG. 1 shows two telephones or SIP terminals 110 and 130 that belong to two fictitious users named Alice (111) and Bob (131). These terminals 110 and 130 include the functionalities for the entities that the SIP protocol terms “User Agent Client” and “User Agent Server.” For this reason, in the SIP protocol, the terminals used by the users are called “User Agent.”

Terminals 110 and 130 have network interfaces represented by elements 115 and 135 respectively. The SIP Proxy server 120 has a network interface represented by element 125.

These terminals 110 and 130, together with the SIP Proxy 120, exchange messages using the SIP and RTP protocols. These messages are encapsulated in IP packets.

The heavy lines 112, 122 and 132 in FIG. 1 indicate the origin and destination of each message and facilitate understanding of the time-line of the exchanged messages, which take place in the descending order represented between these lines.

The messages using the SIP protocol are indicated by the arrows 140, 142, 144, 146, 148, 150, 152, 154 and 156. The origin and destination of the IP packet that carry the SIP message are indicated by the direction of the arrow.

The heavy line 160 represents the exchange of multimedia content between terminals using, for example, the RTP protocol. The multimedia content can be a telephone conversation between Alice and Bob, for example.

FIG. 1 illustrates one characteristic of the SIP protocol that hinders the legal interception of the communications. This characteristic is that the multimedia content of the communication, represented in FIG. 1 by the heavy line 160, which uses the RTP or “Real Time Protocol,” is transmitted directly between Alice's terminal 110 and Bob's terminal 130. As a result, the IP packets that encapsulate the multimedia content using the RTP protocol do not pass through the SIP Proxy 120.

A more detailed explanation of the SIP session establishment showed in FIG. 1 follows below.

Alice knows the IP address of the SIP Proxy server 120 that Bob uses to establish SIP sessions, and sends 140 an INVITE-type SIP message 141 from her SIP terminal 110, to the SIP Proxy 120. This SIP Proxy 120 resends the INVITE message 143, by means of the communication 142, to Bob's SIP terminal 130.

This INVITE-type SIP message 141, 143, includes a unique SIP session identifier in the form of a SIP field or header called “Call-ID.” It also includes information about the means that Alice wants to use to establish the SIP session with Bob. In order to describe these means, the SIP protocol uses a second protocol called “Session Description Protocol” (SDP).

The SDP protocol is described in specifications RFC 2327, M. Handley et al., April 1998, published on-line by the IETF and currently available at the Internet address www.ietf.org/rfc/rfc2327.txt.

Included in the information that the INVITE-type SIP message transmits using the SDP protocol, is the IP address of the network interface 115 of Alice's terminal 110 from which the multimedia content will be transmitted, the type of protocol that will be used to transmit the multimedia information, for example RTP, and the port that will be used for the multimedia transmission.

When Bob's terminal 130 receives the INVITE message 143, he answers, sending by means of the communication 144, a “180 Ringing”-type SIP message 145 to the SIP Proxy 120 and the SIP Proxy 120 resends it by means of the communication 146 to Alice's terminal. Simultaneously, Bob's terminal 130 emits a sound or some type of signal to indicate to Bob that a call is arriving.

When Bob decides to accept Alice's call, for example by picking up the handset of the terminal 130, Bob's terminal 130 sends by the communication 140, a “200 OK” type SIP message 149 to Alice's terminal by means of the SIP Proxy 130. This “200 OK” message includes information, also described by the SDP protocol, about the means Bob wishes to use to send the multimedia content, including the IP address and the port that the terminal 130 will use to send the multimedia content, and the type of protocol to be used for sending the content, which could be the RTP protocol, for example.

The last step in establishing the SIP session is that Alice's terminal 110 sends an “ACK”-type SIP message 153 by means of the communication 152 to confirm to Bob that she has received his response. This message 153 is encapsulated in an IP packet that is sent directly from Alice's terminal to Bob's terminal without passing through the SIP Proxy 120. To do this, Alice uses the IP address that Bob has indicated by means of the SDP protocol in his “200 OK” message 149.

It is at this time that the SIP session is already established and the terminals 110 and 130 can exchange multimedia content 161 using a protocol such as the above-mentioned RTP protocol, for example. The communication of the multimedia content, represented in the FIG. 1 by the heavy line 160, takes place directly between Alice's terminal 110 and Bob's terminal 130, without passing through the SIP Proxy 120.

The “BYE”-type 155 and “200 OK”-type 157 SIP messages are used to terminate the SIP session.

FIG. 2 shows a very common network topology called “SIP trapezoid.” In this topology, two SIP terminals 210 and 230 from different domains establish a SIP session using two SIP Proxy servers 220 and 240, one in each domain.

The term “SIP trapezoid” is used because of the trapezoidal shape formed by the lines 270, 212, 290 and 232 that represent communications using the SIP protocol.

In the configuration shown in FIG. 2, each SIP terminal 210 and 230 is configured to use a SIP Proxy 220 and 240, respectively, to which the SIP messages that carry requests to establish SIP sessions are sent.

For example, when the terminal 210 of Alice 215 wants to establish a session with the terminal 230 of Bob 235, the terminal 210 sends an INVITE-type SIP message 213 to the Proxy 220 by means of the communication 212. An explanation of the steps that the INVITE message takes until it reaches the terminal 230 that user Bob is using, follows below.

Adopting the customary designation used by the RFC and IETF specifications, the term “header” will be used to refer to information transmitted by means of the lines of text from the SIP protocol, and the term “field” to refer to information transmitted by means of lines of text from the SDP protocol.

The INVITE message sent by the terminal 210 to the Proxy 220 includes a series of headers and fields containing information, some of which are described herein. A header called “To” that includes a special URI (“Uniform Resource Identifier”) for the SIP protocol called SIP URI which identifies the resource to which the INVITE message is intended. For example, the destination SIP URI of the INVITE message could be the URI sip:bob mediapatents.com. A header called “From” that includes a SIP URI that identifies the originating resource sending the SIP message, for example alice@example.com. A SIP header called “Call-ID” which is a unique identifier for the SIP session it wants to establish. A series of fields that use the above-mentioned SDP protocol. Included in the SDP fields is information about the originating IP address that the terminal 210 will use to send the multimedia data in the communication 280, as well as the port and the type of protocol to be used for the multimedia communication, for example the RTP protocol.

The SDP field used to indicate the IP address that the terminal 210 will use in the multimedia communication 280, is the field called “connection” that begins with the letter “c”. In FIG. 2, the IP address of Alice's terminal is represented by the element 214, which has the value 100.101.102.103. In this case, the INVITE message sent by Bob will contain the following line of text in the SDP protocol:
C=IN IP4 100.101.102.103

Where the parameter IN refers to the Internet and the parameter IP4 indicates that the address that follows, 100.101.102.103, is of the IP version 4 type.

When the Proxy 220 receives the INVITE message addressed to the resource sip:bob@mediapatents.com, it uses the DNS protocol to locate the SIP Proxy Server for the domain “mediapatents.com” to which Bob belongs. To do that, the SIP Proxy 220 communicates with the DNS server 250 by the communication 221 using a message in the DNS protocol called “query”, of a special type called “DNS SRV”, that uses the DNS protocol to locate resources that provides services, in this case the SIP Proxy 240 of the “mediapatents.com” domain.

The DNS server 250 answers, sending the IP address of the SIP Proxy 240 for the domain “mediapatents.com” to which Bob belongs. This exchange of messages using the DNS protocol in the communication 221 is represented by means of the element 222 in FIG. 2.

When the Proxy 220 knows the IP address of the Proxy 240, it transmits the INVITE message 291 to the Proxy 240 by means of communication 290. Normally the communication 290 uses a security protocol such as, for example the TLS (Transport Layer Security) protocol.

When the Proxy 240 receives the INVITE message addressed to the resource detailed in the SIP URI “sip:bob@mediapatents.com,” the Proxy 240 locates the resource and transmits the INVITE message to it. In FIG. 2 the resource sip:bob@mediapatents.com is associated with the terminal 230 and the Proxy 240 sends the INVITE type SIP message by means of the communication 232 to the terminal 230.

In order to locate the resource sip:bob@mediapatents.com, the Proxy SIP 240 can use different locating services. In section “10 Registration,” the RFC 3261 specifications that define the SIP protocol refer to this location service as an abstract service called “Location Service” that allows users to be located within a specific domain associating the two types of URI explained below. The network interface between the SIP Proxy and the “Location Service” is not defined in the RFC 3261 specifications.

The SIP protocol defines two types of SIP URI. A first type of URI is associated with users, and a second type of URI is associated with devices.

SIP URIs associated with users are called “Address-of-Record” URIs (AOR URI). For example, user Bob can use the URI sip:bob mediapatents.com and print this URI on his business cards. This URI would generally be the way to contact user Bob, and is normally included in the “To” and “From” headers of the SIP messages.

The SIP URIs associated with devices, also called “device URI” or “contact URI,” make it possible to direct SIP messages to the device that each user uses at any time. For example, in FIG. 2, user Bob is using the terminal 230 which is associated with the “contact URI” 200.201.202.203, which is the IP address, represented by the element 234 that the terminal 230 uses to establish multimedia communications. Normally information about the URI associated with a device used by a user is included in the “Contact” header of the SIP messages.

Although there are many ways to provide the “Location Service,” the SIP protocol defines a special type of server called “SIP registrar” that is responsible for relating the “Address-of-Record URI” with one or more “device URI”, storing this information in a database.

When a user changes device, he can send a “REGISTER”-type SIP message to the “SIP registrar” server in order to associate his “AOR URI” with one or more “device URI”.

In FIG. 2, when the Proxy 240 receives an INVITE message addressed to the URI sip:bob@mediapatents.com, the Proxy 240 ascertains the “device URI” by means of the communication 241 with the “Location Server” 260 that provides the “Location Server” services. This server transmits the information which informs that the AOR URI sip:bob@mediapatents.com is associated with the “device URI” 200.201.202.203 and the Proxy 240 retransmits the INVITE message 233 by means of the communication 232 to the IP address of the terminal 230 which is the IP address belonging to the “device URI.” In this way, the INVITE message reaches the terminal 230 that Bob is using at that time.

The stream of SIP messages to establish the SIP session continues as described above in FIG. 1 until the SIP session is established facilitating the exchange of SIP messages 271 directly between the two SIP User Agents and the commencement of the multimedia communication 280 which exchanges multimedia content 281 directly between addresses IP 100.101.102.103 of the terminal 210 and IP 200.201.202.203 of the terminal 230.

In theory the SIP protocol can function using multicast technology, but in practice the Internet does not yet allow the transmission of data using multicast technologies because many Internet access providers do not allow the transmission of multicast data packets. This represents a limitation in the use of the SIP protocol.

Multicast technology makes it possible to send data from a single source to many recipients over a data network, without the need to establish a unicast communication, i.e. an individual one-to-one communication between the source and each of the recipients. To do this, the source sends data, in the form of data packets, to a single address associated with a multicast group, to which devices interested in being recipients of the data transmission can subscribe. This address, called multicast address or multicast group address, is an IP (Internet Protocol) address selected from a range reserved for multicast applications. The data packets sent by the source to the multicast address are then replicated by the different network routers in order to reach the recipients who have joined the multicast group.

Messages exchanged between a client device or host and the router for the purpose of managing membership in a multicast group, use the IGMP (Internet Group Management Protocol) or the MLD (Multicast Listener Discovery) protocol, depending on whether the router operates with version 4 (IPv4) or version 6 (IPv6) of the IP (Internet protocol), respectively.

When there is a proxy between the host and the router, the proxy also uses IGMP/MLD protocols to exchange multicast group membership messages with the host, the router or another intermediate proxy. In these cases, the proxy can receive from different hosts, requests for subscription to, or cancellation from, a multicast group, and it groups them together to reduce the IGMP/MLD message traffic it sends to the router. Henceforth, the generic term “proxy IGMP” will be used to designate a proxy that uses the IGMP/MLD protocols.

Furthermore, the routers exchange messages between each other in order to define the routing that facilitate efficient routing of the data from the sources to the devices that have subscribed to a multicast group. To do this, the routers use specific protocols, of which the PIM-SM (Protocol Independent Multicast—Sparse Mode) is the most widely used.

All the protocols referred to are defined and documented by the Internet Engineering Task Force (IETF).

The version of the IGMP protocol currently in use is IGMPv3, which is described in the RFC 3376 specifications published on-line by the IETF (B. Cain et al., Engineering Task Force, Network Working Group, Request for Comments 3376, October 2002, currently available at the Internet address http://tools.ietf.org/html/rfc3376).

With respect to the MLD protocol, the version currently in use is MLDv2, which is described in the RFC 3810 specifications published on-line by the IETF (R. Vida et al., Engineering Task Force, Network Working Group, Request for Comments 3810, June 2004; currently available at the Internet address http://tools.ietf.org/html/rfc3810).

The operation of an IGMP proxy is described in the RFC 4605 specifications published on-line by the IETF (B. Fenner et al., Engineering Task Force, Network Working Group, Request for Comments 4605, August 2006; currently available at the Internet address http://tools.ietf.org/html/rfc4605).

The PIM-SM protocol used for communication between routers is described in the RFC 4601 specifications published on-line by the IETF (B. Fenner et al., Engineering Task Force, Network Working Group, Request for Comments 4601, August 2006; currently available at the Internet address http://tools.ietf.org/html/rfc4601).

### SUMMARY

An online advertising insertion system and method that allows an improved geographic segmentation is provided.

In accordance with one embodiment, a method is provided that comprises establishing a multimedia communication in real-time with a first network node in a data network using an IP-based communications management protocol, receiving from the first network node a multimedia content that includes geotagging data in the form of geographic coordinates, determining from the geographic coordinates that the multimedia content is associated with an event, selecting an advertising content based on the event to create a multimedia file that contains and at least a part of the multimedia content and also the advertising content; and transmitting at least a part of the multimedia file to a second network node in the data network.

In accordance with another embodiment, a method is provided that comprises establishing a multimedia communication in real-time with a first network node in a data network using an IP-based communications management protocol, receiving from the first network node a multimedia content, and determining from data of the multimedia content the geographic coordinates of the first network node, determining from the geographic coordinates that the multimedia content is associated with an event, selecting an advertising content based on the event to create a multimedia file that contains and at least a part of the multimedia content and also the advertising content; and transmitting at least a part of the multimedia file to a second network node in the data network.

In accordance with another embodiment, a server in a data network comprising one or more components that function to receive multimedia content in the form of IP packets from a first network node and to combine advertising content with at least a portion of the multimedia content to produce a multimedia file to be transmitted to a second network node is provided, the one or more components of the server comprising hardware and/or software that facilitates (1) establishing a multimedia communication in real-time with the first network node using an IP-based communications management protocol, (2) receiving from the first network node the multimedia content that includes geotagging data in the form of geographic coordinates, (3) determining from the geographic coordinates that the multimedia content is associated with an event, (4) selecting the advertising content based on the event to create the multimedia file; and (5) transmitting at least a part of the multimedia file to a second network node in the data network.

In one implementation, the system and method includes the use of a server for transmitting over a data network advertising content inserted in multimedia content associated with an event, the server receives from a first network node connected to the data network advertising content to be inserted in multimedia content associated with an event that occurs at a specific time and place, and the server receives a message, by means of a first IP-based communications management protocol, in order to establish a multimedia communication in real-time by means of IP packets with a second node of the data network, and the server establishes a multimedia communication with the second network node, and the server receives from the second network node multimedia content that includes geotagging data in the form of coordinates, and the server determines from the coordinates that the multimedia content is associated with the event, and the server creates a multimedia file that contains the advertising content and at least a part of the multimedia content, and the server transmits at least a part of the multimedia file to a third network node.

In one implementation, the server transmits to the third network node at least part of the multimedia file while it is receiving the multimedia content that includes geotagging data in the form of coordinates, from the second network node.

In another implementation, the server transmits in real-time to a third network node a part of the multimedia content that it is receiving in real-time from the second network node.

In another implementation, the server simultaneously transmits different parts of the multimedia file to different network nodes.

In one implementation, the server determines the time at which the multimedia content that it is receiving from the second network node has been captured, by means of data or metadata that the second network node transmits together with the multimedia content.

In one implementation, the server determines the time at which the multimedia content that it is receiving from the second network node has been captured, based on the time at which the server receives the multimedia content.

In one implementation, the server establishes a multimedia communication with the second network node using the SIP protocol.

In one implementation, the server receives the multimedia content from the second network node using the RTP protocol.

In one implementation, the server transmits at least part of the multimedia file using a streaming protocol.

In one implementation, the streaming protocol is the RTSP protocol.

### BRIEF DESCRIPTION OF THE DRAWINGS

Other advantages and characteristics of the invention can be seen from the following non-limiting description of some exemplary embodiments of the invention, with reference to the appended drawings.

FIG. 1 shows an example of SIP session establishment using a SIP Proxy type server.

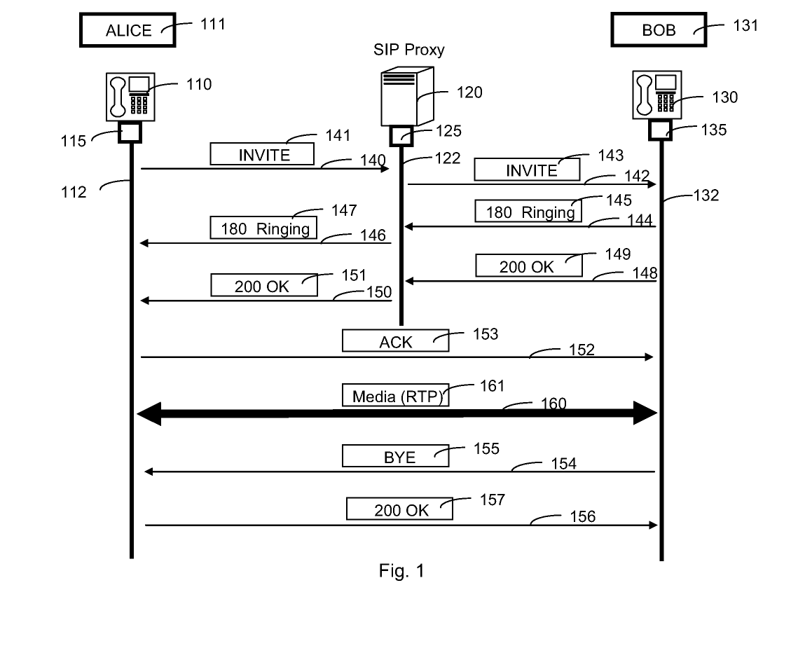

FIG. 2 shows a communication configuration that uses two SIP Proxy, generally known as “SIP Trapezoid.”

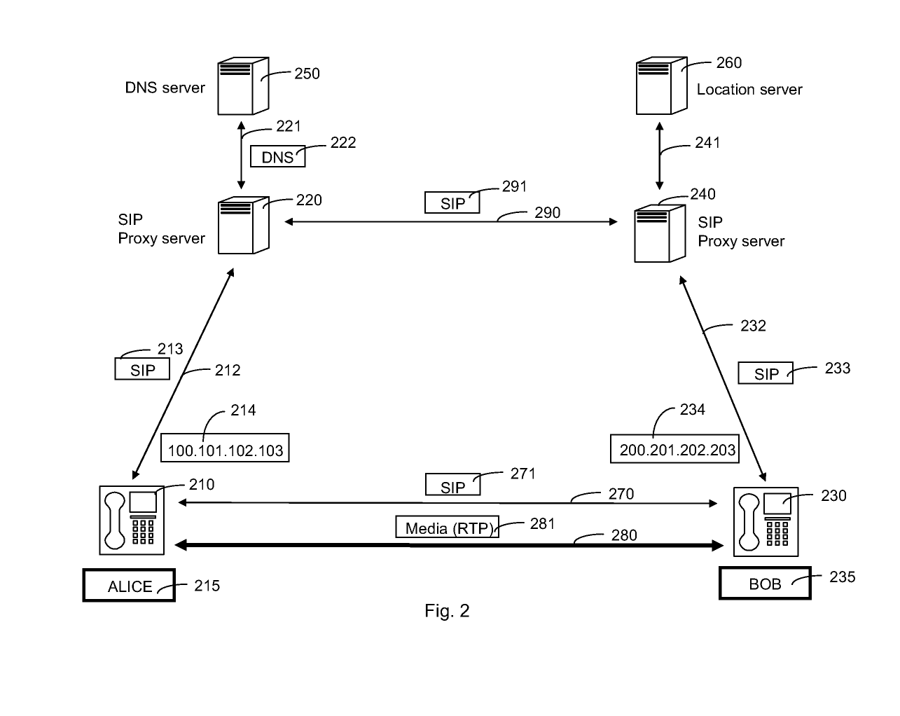

FIG. 3 shows an example of a system for transmitting multimedia content between a transmitting device and a plurality of receiving devices.

FIG. 4 shows a system for transmitting multimedia content between a transmitting device and a plurality of receiving devices in one embodiment of the present invention.

FIG. 5 shows the operation of a streaming server in one embodiment of the resent invention.

FIG. 6 illustrates a system and method of an embodiment of the present invention.

### DETAILED DESCRIPTION

For several years the custom of sending video files to specific web sites so that other users can play the video files has been widespread among users of the Internet.

One very well known web site that has millions of videos sent by users is http://www.youtube.com.

However, one problem with this type of web site is that advertising revenue is limited because it is difficult for the advertisers to select the content with which they wish to include their advertisements.

Because videos are incorporated on this type of web site without human supervision, it is possible that the content of some videos is not very suitable for the advertisers, and it is also difficult to segment the millions of videos that are transmitted by users.

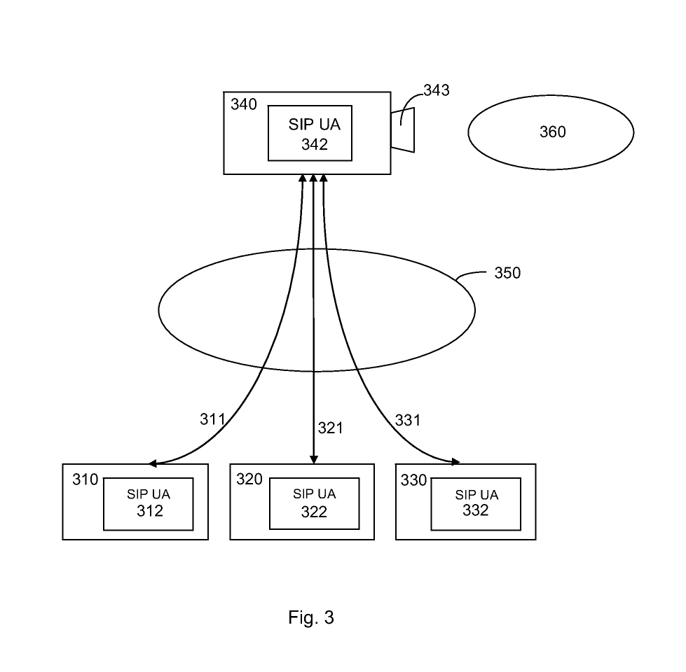

FIG. 3 shows various problems that occur during the transmission of multimedia content in a communication between different network nodes 310, 320, 330 and 340 in a data network 350, for example the Internet.

In FIG. 3, the node 340, which can be, for example, a mobile telephone that has a video camera 343, transmits multimedia content about an event 360 to the nodes 310, 320 and 330 using the communications represented by lines 311, 321 and 331 respectively. The event 360 can be, for example, an automobile race, a tennis match or any other type of event that can take place at a specific venue and over a specific period of time.

In the example shown in FIG. 3, the different nodes communicate with each other using a packet-based IP communications protocol, such as the above-mentioned SIP protocol. To do this, each of the four nodes 310, 320, 330 and 340 has a SIP User Agent 312, 322, 332 and 342 respectively.

In FIG. 3, the nodes 310, 320 and 330 are interested in receiving the multimedia content related to the event 360. However, FIG. 3 shows various problems hindering the nodes 310, 320 and 330 receipt of the multimedia content related to the event 360 that the node 340 is transmitting.

A first problem is that the nodes 310, 320 and 330 interested in receiving multimedia content associated with the event 360, must be aware that there is a node in the network, node 340, that is transmitting multimedia information related to the event, and must be aware of the data concerning the node 340, for example, its IP address or its SIP URI, in order to locate it and establish communication with the node 340 over the network 350.

A second problem is that the node 340 has a limited bandwidth and can only communicate with a limited number of network nodes at the same time. As was explained above, multicast technology would allow node 340 to transmit multimedia content to numerous nodes of the network 350, but currently the Internet does not allow the use of multicast technology.

A third disadvantage is that the SIP protocol only allows the nodes 310, 320 and 330 to receive the multimedia content (e.g., images of the event 360) that the node 340 is transmitting in real-time and for example, does not allow transmission to the node 310 of the multimedia content that the node 340 transmitted five minutes earlier, while at the same time transmitting the multimedia content in real-time to nodes 320 and 330.

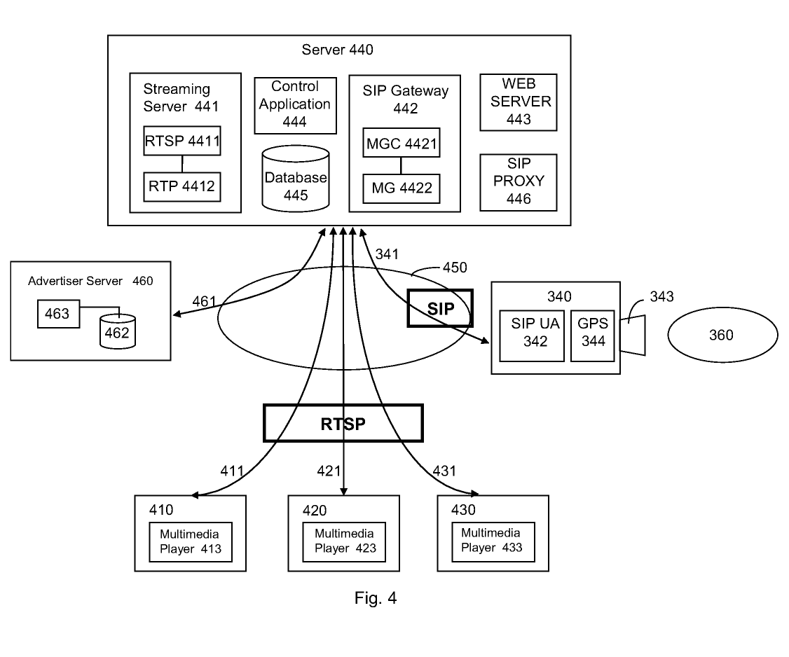

FIG. 4 illustrates an embodiment of the present invention which provides an improved system of establishing a session and transmission of multimedia content between a transmitting device and a plurality of receiving devices that wish to receive the multimedia content.

FIG. 4 shows different devices 440, 460, 340, 410, 420 and 430 that communicate with each other over a data network 450, for example, the Internet, using communications indicated by the arrows 461, 411, 421, 431 and 341.

Node 340 of FIG. 4 can be a mobile telephone, for example, that has a video camera 343 and a GPS (Global Positioning System) receiver 344, and a SIP User Agent 342 that allows it to establish multimedia communications with the network device or server 440.

In FIG. 4, the server 440 includes different modules or applications that can be executed on a single server or on a plurality of servers connected in a network.

Network device or server 440 contains a SIP Proxy 446 that allows communications to be established by means of the SIP protocol, a SIP Gateway 442, a streaming server 441, a web server 443, a control application 444 and a storage medium or database 445.

FIG. 4 also shows an Advertiser Server 460 and three network nodes 410, 420 and 430 each of which has a multimedia player 413, 423 and 433 respectively.

In FIG. 4, the Advertiser Server 460 transmits advertisements to the server 440, for example, in the form of video or text, so that the server 440 insert them into multimedia content associated with an event 360 that takes place or will take place at specific time and at a specific geographic location.

The Advertiser Server 460 can use different protocols to transmit the advertisements to the server 440, such as the HTTP, FTP protocols or Web Services. The Advertiser Server can also have a database 462 where its advertisements are stored.

In one embodiment, the advertiser server has a browser 463 and uses the HTTP protocol to access the web server 443 where it selects, for example, the event 360 from a list of events stored in the database 445 and which is displayed in the browser 463. Once event 360 is selected in which the advertiser server wishes to insert its advertising content, the advertiser server transmits the advertising content to the web server 443 which stores it in the database 445 together with the identification of the event 360 in which the advertiser server wishes to insert its advertising content.

Network node 340 has a video camera 343 that it uses to capture multimedia content related to an event 360, and it transmits the multimedia content to the server 440, including in that content geotagging data or metadata that indicates, by means of coordinates that represent the geographic location where the multimedia content being transmitted was captured.

To do this, the node 340 can use different technologies that allow it to determine its geographic position, such as the GPS 344 shown in the Figure for example. However, the node 340 can also determine its geographic position using different location systems as explained below.

Geotagging is the process of adding identification data or metadata to multimedia content, that indicates where the multimedia content was captured. For example, in a photograph, the geotagging can consist of the geographic coordinates such as the latitude and longitude of where the photograph was taken, although it can also include data such as altitude. In a video, geotagging can consist of geographic coordinates for each frame of the video, for example.

Two known formats for adding metadata with geotagging information are the formats called “Extensible Image File Format” (EXIF) and “Extensible Metadata Platform” (XMP). These geotagging formats are known to persons skilled in the art and are not explained in greater detail. The present invention can use these geotagging formats, or any other type of format that facilitates the determination of geographic coordinates.

Optionally, the multimedia content that the node 340 transmits to the server 440 can also contain data or metadata that indicates the time at which the multimedia content was captured, for example indicating the exact time that each frame of the video was captured.

The node 340 transmits the multimedia content to the server 440 by means of a multimedia communications protocol, such as the above-mentioned SIP protocol, for example, and includes in the multimedia content, the geotagging data that indicates, by means of coordinates, the geographic location of the node 340 at the time the multimedia content was captured.

In order to establish the SIP communication with the server 440, node 340 can use, for example, the SIP Proxy 446 and the SIP Gateway 442.

A SIP gateway is an application that uses the SIP protocol to interact with another application or data network that uses a different protocol. In terms of the SIP protocol, a SIP gateway is a special type of SIP user agent that functions in order to interact with another application or data network, instead of interacting with a person. The SIP gateway is the termination point for the SIP communication as well as for the exchange of multimedia data between the two ends of the SIP communication.

For example, a SIP gateway can be used to interconnect a network that uses the SIP protocol with another network that uses a different protocol such as H323 or PSTN (Public Switched Telephone Network).

A SIP gateway can be formed, for example, by a Media Gateway or MG 4422, and a Media Gateway Controller or MGC 4421. The MGC manages the connection protocol used to establish the communication (signaling) while the MG is responsible for the multimedia data, for example using the RTP protocol.

In FIG. 4, the SIP gateway 442 makes it possible to convert the multimedia data that the server 440 receives from the network node 340, using the RTP protocol, for example, and to store it in the database 445 in an appropriate format so that advertising content can be added to the multimedia content, and the multimedia content, together with the advertising content, can be transmitted to a plurality of network nodes 410, 420, 430 by means of the streaming server 441.

For this purpose, in one embodiment, the server 440 uses a control application 444 that reads the geotagging data in the form of coordinates from the multimedia content that the server 440 receives from the network node 340. From the geotagging data, in the form of coordinates, and from the time the node 340 has recorded the multimedia content, control application 444 establishes that the multimedia content is associated with an event 360, and therefore the advertising content received from the Advertising Server 460 can be inserted into the multimedia content, and the multimedia content, together with the advertising content, can be transmitted by means of streaming server 441.

The control application can detect the time at which the network node 340 captured each frame of the multimedia content in various ways. In a first way, the network node 340 itself includes, in each video frame, data or metadata that indicates the exact time each video frame was captured.

In a second way, the server 440 detects the time it receives each video frame from the network node 340, and stores that information together with the multimedia content. This second way is especially suitable when the network node 340 transmits the multimedia content to the server 440 in real-time.

The network nodes 410, 420 and 430 that are interested in receiving multimedia content related to the event 360, can access this content by means of the server 440, for example, using a browser to access a web page from the web server 443 that shows a list of multimedia content received, or which the server 440 is receiving in real-time and which is associated with the event 360.

The network nodes 410, 420 and 430 can select from the web page of the server 443 the event 360 and choose from different videos associated with that event 360, such as video transmitted by the network node 340 for example, and begin to download and play the multimedia content associated with the event 360 using, for example, a streaming protocol to play the multimedia content in the multimedia players 413, 423 and 433.

FIG. 4 shows a single network node 340 transmitting multimedia content to the server 440 for a single event 360, but it can have a plurality of network nodes, for example mobile telephones with a video camera that transmit multimedia content associated with an event or a plurality of events. This is possible, for example, at sporting events where there are thousands of spectators who have mobile telephones with video cameras.

In the example of FIG. 4, the streaming server uses the RTSP protocol to transmit multimedia content that is played by the multimedia players 413, 423 and 433. However, other streaming protocols, such as, for example, the Adobe Flash or Microsoft Silverlight streaming protocols may be used.

In one implementation multimedia files are transmitted that allow downloading and progressive display, so that the content of the multimedia file can begin to be displayed by a multimedia player while it is being downloaded and without waiting for the entire file to be downloaded.

A brief explanation of the operation of the RTSP streaming protocol used in the embodiment of FIG. 4 follows.

The RTSP protocol (Real-Time Streaming Protocol) is described in the RFC 2326 specifications published on line by the IETF (H. Schulzrinne et al., Internet Engineering Task Force, Network Working Group, Request for Comments 2326, April 1998; currently available at the Internet address http://www.ietf.org/rfc/rfc2326.txt).

The operation of the RTSP protocol is closely related to two other IETF (Internet Engineering Task Force) protocols, the SDP and RTP protocols.

The SDP (Session Description Protocol) protocol is described in the RFC 4566 specifications published on line by the IETF (M. Handley et al., Request for Comments 4566, Network Working Group, July 2006; currently available at the Internet address http://www.ietf.org/rfc/rfc4566.txt).

The RTP (Real-time Transport Protocol) protocol is described in the RFC 3550 specifications published on-line by the IETF (H. Schulzrinne et al., Request for Comments 3550, Network Working Group, July 2003; currently available at the Internet address http://www.ietf.org/rfc/rfc3550.txt).

Currently there is a new draft of the RTSP protocol called RTSP 2.0. It is described in the document published on line by the IETF “Real Time Streaming Protocol 2.0 (RTSP) draft-ietf-mmusic-rfc2326bis-19.txt,” H. Schulzrinne et al., MMUSIC Working Group, Nov. 3, 2008, currently available at the Internet address http://www.ietf.org/internet-drafts/draft-ietf-mmusic-rfc2326bis-19txt).

Another protocol related to the RTSP is the HTTP protocol (Hypertext Transfer Protocol) described in the RFC 2616 specifications published on line by the IETF (R. Fielding et al., Request for Comments 2616, Network Working Group, June 1999, currently available at the Internet address http://www.w3.org/Protocols/rfc2616/rfc2616.html).

The RTSP protocol is a client-server protocol based on text messages, designed to facilitate communication between a client and a streaming server in such a way that the client controls the streaming transmission from the server using the RTSP protocol as though it were a remote control for the server. The client can be any device that can play a multimedia stream, such as a computer, a PDA, a mobile telephone, and in general any device that incorporates an audio or video player.

RTSP makes it possible to establish and control one or more data flows from the streaming server to the multimedia player. We will use the term “stream” to refer to each of these data flows.

In the embodiment of FIG. 4, the RTSP protocol is the protocol used by the multimedia player to communicate to the streaming server the content it wishes to receive by means of RTSP messages. The streaming server also sends to the multimedia player RTSP messages with information about the selected content and the way in which it will be transmitted to the multimedia player.

The RTSP protocol uses the term “presentation” to refer to a set of streams that are presented to the client as a group and which are defined in a presentation file called “Presentation Description” or “Presentation Description File.” Other protocols use different names to refer to a presentation. For example, the SDP protocol uses the term “session” to refer to a presentation.

This presentation file contains information about each stream, including for example, information about whether it is an audio or video stream, the type of coding used, Internet addresses needed to access each stream, etc.

The presentation file can use various formats to describe this information. The SDP protocol is usually used most, although it is not necessary to use the SDP protocol, and the RTSP protocol can describe this information using protocols other than SDP.

A presentation file is normally identified by means of a URI (Uniform Resource Identifier). For example, the following URI could be used to identify a presentation file: rtsp://media.example.com:554/twister/audiotrack

The client can access the presentation file using the RTSP protocol or other protocols, such as the HTTP protocol (Hypertext Transfer Protocol). The client can also receive the file that describes the presentation, by e-mail or any other means.

RTSP uses the term “container file” to refer to a multimedia file that contains the data from one or more streams which normally form a presentation when they are played together. For example, a container file can contain three streams: a first video stream of a film, a second stream of the film's audio in the English language, and a third stream with the audio in the Spanish language.

RTSP uses the term “RTSP session” to define an abstraction (for example a software module being executed on the streaming server) that uses the streaming server to control each presentation it sends to each user. Each RTSP session is created, maintained and deleted by the server. Normally a client requests the creation of a session by sending the SETUP command from the RTSP protocol to the server, and receives from the server an RTSP response called RESPONSE message with an identifier for the session created.

RTSP sessions maintain information about the status of each presentation requested by each user. This is an important difference with respect to the HTTP protocol, which is a protocol that does not maintain the status of requests from the client.

Another important difference is that in the RTSP protocol, the server can send RSTP messages with commands to the client, as well as receive them. The following Table 1, extracted from the RFC 2326, details the different commands, messages or methods in RTSP terminology that can be sent between the client and the server.

TABLE 1

| Method | Direction | Object | Requirement |
|---|---|---|---|
| DESCRIBE | C→S | P, S | recommended |
| ANNOUNCE | C→S, S→C | P, S | optional |
| GET_PARAMETER | C→S, S→C | P, S | optional |
| OPTIONS | C→S, S→C | P, S | required |
| | | | (S→C: optional) |
| PAUSE | C→S | P, S | recommended |
| PLAY | C→S | P, S | required |
| RECORD | C→S | P, S | optional |
| REDIRECT | S→C | P, S | optional |
| SETUP | C→S | S | required |
| SET_PARAMETER | C→S, S→C | P, S | optional |
| TEARDOWN | C→S | P, S | required |

The RTSP server can send the data packets for each stream to the client using the RTP protocol, but RTSP does not depend on the RTP protocol and could use other transport protocols.

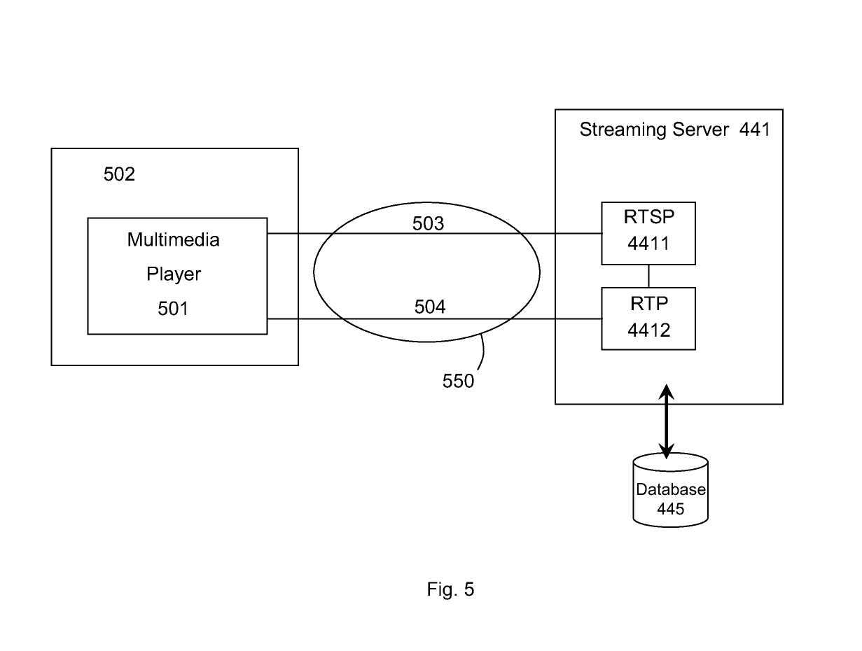

FIG. 5 shows in greater detail, an operation of the streaming server 441 in accordance with one embodiment. In the embodiment of FIG. 5 a multimedia player 501 of a device 502 communicates with the streaming server 441 which uses the RTSP and RTP protocols. The device 502 can be a personal computer, a PDA, a mobile telephone or any other device that can have a multimedia player 501.

The streaming server 441 has an RTSP 4411 module and an RTP 4412 module which are executed in the server 441. These modules RTSP 4411 and RTP 4412 are responsible for the RTSP and RTP communications with the multimedia player, respectively. Both modules operate in coordination on the streaming server and communicate with each other.

The streaming server can access the database or storage medium 445 where multimedia files can be stored, for example files with audio and/or video.

FIG. 5 shows the RTSP communication between the multimedia player and the RTSP module of streaming server 441 by means of the line 503. The multimedia player and the streaming server use this communication to exchange messages in the RTSP protocol.

The RTP communication is shown by means of the line 504 and is used by the streaming server to send RTP packets to the multimedia player, and also by the streaming server and the multimedia player to exchange control packets using a protocol called RTCP which forms part of the RTP protocol.

The communications represented by the lines 503 and 504 can use a data network 550, such as the Internet for example.

Although in FIG. 5 the two communications RTSP and RTP are shown by two lines, both communications can also function sharing the same connection, such as a TCP/IP connection. Another common alternative is that the RTP protocol uses two different connections such as, for example, a first TCP/IP connection for the RTP packets and a second TCP/IP connection for the RTCP packets. In order to simplify the figure, one line has been used for the RTSP communications and another line for the RTP and RTCP communications.

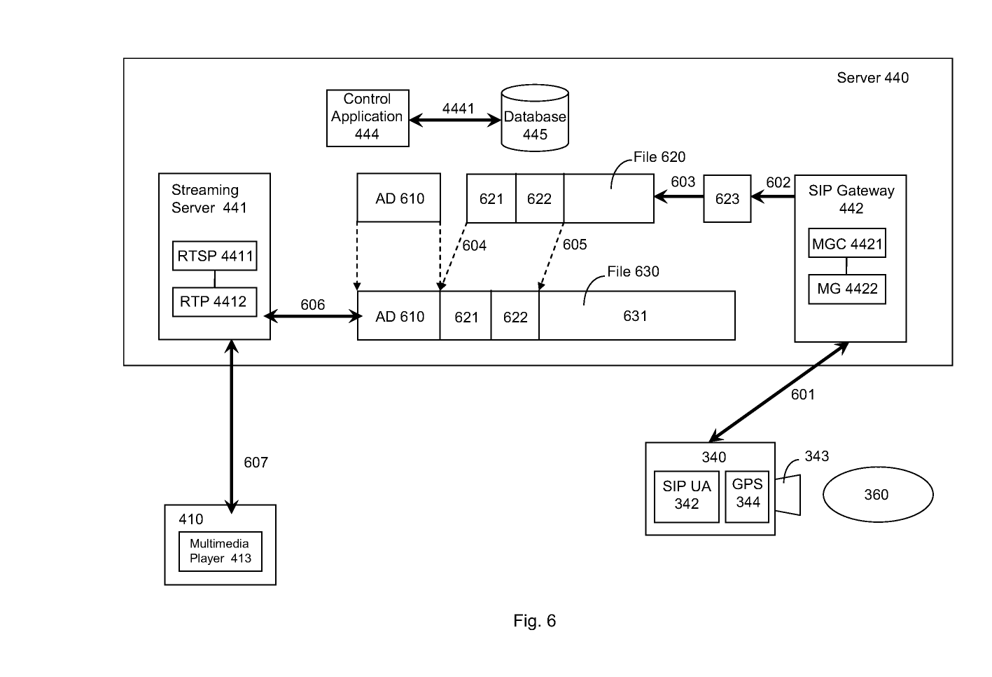

FIG. 6 shows an embodiment of the present invention that shows different steps 601, 602, 603, 604, 605, 606 and 607 the multimedia data may take while being transmitted by the network node 340 to a network node 410.

By means of the communication 601, the node 340 transmits to the SIP Gateway 442, multimedia content related to an event 360 that includes geotagging data in the form of coordinates. The communication 601 can use, for example, the above-mentioned SIP and RTP protocols. Optionally, the SIP Proxy 446, not shown in FIG. 6, can be used to establish the communication 601.

The MG 4422 module of the SIP Gateway 442 can receive the multimedia content transmitted by the node 340, for example, in the form of numbered RTP packets, and can store the multimedia content in a first file 620 in the database or storage medium 445.

For greater clarity, a brief explanation of the meaning of some fields that are used in the RTP packets that transmit the multimedia content follows. Detailed information about the RTP protocol is found in the above-mentioned RFC 3550 specifications.

The “Payload” field at the end of the RTP packet is the one that includes the stream's multimedia content. For example, it can include audio or video.

The “Sequence number” field of the RTP data packets is a 16-bit integer number that is incremented by one unit each time an RTP packet from a stream is transmitted. It is used primarily so that the receiver of the RTP packets can identify lost data packets and can arrange the RTP packets that arrive at the receiver in an order different than the order in which they have been sent.

The “Synchronization source (SSRC) identifier” is a 32-bit field used as unique identifier of each RTP stream that each data source sends. If several streams are sent in one multimedia transmission, for example audio and video, each stream has its own SSRC identifier.

The “Timestamp” field is a 32-bit integer number that indicates the instant in which the sampling was done or when the first byte of the content data of the RTP packet was captured, i.e., when the first byte of the Payload was sampled or captured by the camera. Each stream transmitted by RTP packets uses its own “RTP clock” to calculate the time at which the sampling or capture of the first byte was done. The RTP clock of each stream is a clock that increments linearly and constantly. When the clock reaches its maximum value (the 32 bits having the value 1) it starts over again at zero. For security reasons, the initial value of the timestamp field is selected randomly. The timestamp values for different streams of the same multimedia file being transmitted using the RTP protocol can increase at different speeds and take different initial values.

FIG. 6 shows how the file 620 is increasing with the multimedia content of each packet or set of RTP packets that the MG 4422 module receives. Thus, for example, the parts 621 and 622 of the multimedia file 620 can correspond to multimedia content that the MG 4422 module has already stored in the file 620, and the content of the element 623 can originate from a new RTP packet that the MG 4422 module has received. The lines 602 and 603 represent the process of storing in the file 620, the multimedia content 623 received by MG 4422 by means of one or more RTP packets.

The SIP Gateway 442 can store the geotagging data in the form of coordinates that it receives from the network node 340 in the same file 620 or in separate records from the database 445.

The database or storage medium 445 also stores advertising content AD 610, for example, in the form of video or images it has previously received from the Advertiser Server for insertion in multimedia content associated with the event 360. Alternatively, the advertising content AD6 10 may be stored in a location other than storage medium 445.

In FIG. 6, the control application 444 can access the contents of the database or storage medium 445 by means of the communication 4441.

When the SIP Gateway 442 begins to store the multimedia content that it receives from the network node 340 in the file 620, the control application 444 reads the geotagging data in the form of coordinates associated with the file 620, either by reading the data directly from the file 620, or by obtaining it from database records associated with the file 620 where the SIP Gateway has stored the geotagging data in the form of coordinates that correspond to the file 620.

The control application 444 can determine the moment at which the network node has recorded the multimedia content from the file 620 in different ways.

In a first way, the multimedia content includes data or metadata that details the time it was recorded, for example indicating the exact time each video frame was recorded by means of, for example, the following data: year, month, day, hour, minute, second and thousandth of a second. The SIP Gateway 442 can store this information in the file 620 or in the database records 445 associated with the file 620.

In a second way, for example, if the multimedia content that the network node 340 transmits does not include any data or metadata that details when it was recorded, the SIP Gateway can consider that the node 340 is transmitting the data in real-time, and assign to each video frame of the multimedia content it receives the time at which the video frame is received by the SIP Gateway 442, and store that information either in the file 620 itself or in the database records 445 associated with file 620.

From the geotagging data in the form of coordinates, and from the time when the multimedia content was recorded, the control application 444 can determine that the multimedia content of the file 620 is related to the event 360, and that it is therefore appropriate to insert an advertising content AD 610 stored in the database 445.

Thus, database 445 can store information about different events including data about the geographic area where the event takes place and the start and end time for each event. The geographic area can be stored in the database, for example, in the form of a polygon with geographic coordinates that define the area where each event takes place.

The control application 444 can combine various multimedia files in order to generate new multimedia files. For example, it can combine advertising files with content files to generate a multimedia file that contains advertising and content.

In FIG. 6, the control application 444 creates a new file 630 from the advertising content AD 610 and from the content of the file 620, for example, by adding the beginning of the multimedia content from the file 620 to the end of the advertising content AD 610, as indicated in FIG. 6 by the lines 604 and 605.

Since the content of the file 620 increases as the SIP Gateway 442 receives multimedia data from the network node 340, the content of the file 630 can increase and fill the part 631 of file 630 at the same time as the file 620 increases.

The file 630 can be, for example, a file that is created and stored in the database or storage medium 445. However, this solution requires processing time to create the file 630.

In order to avoid this problem of processing time, the file 630 can be a virtual file, for example a component programmed using the C++ language that is executed in the control application and which reads the information from the file 620 and the information from the advertising content AD 610, and transmits it to the RTSP and RTP modules of the streaming server 441 as though it were the file 630, thus making it unnecessary to create the file 630. In this case, the file 630 is not a stored file, but rather a virtual file that is accessed by the component executed by the control application 444.

By means of the communication 606, the streaming server 441 accesses the content of the file 630, whether the file is stored in the database 445 or is a virtual file, and transmits it to the network node 410 by means of the communication 607 using, for example, a streaming protocol such as the RTSP protocol.

In another embodiment, the virtual file 630 can be created on the streaming server 441. In this case, it is the streaming server 441 that executes the component that reads the file 620 and the advertising content AD 610 and combines them to form the virtual file 630.

FIG. 6 shows a GPS module 344 forming part of the network node 340 in such a way that network node 340 can add the geotagging data, in the form of coordinates, to the multimedia content it captures using the camera 343, as a result of the information it receives from the GPS module. However, alternative positioning methods can be used by the present invention, such as positioning based on assigning geographic coordinates to the IP address of the network node 340.

The book “UMTS NETWORKS, Architecture, Mobility and Services,” by Heikki Kaaranen et al., published by John Wiley & Sons in June 2005 and included for reference, describes in Section “8.3.4 Location Communication Services (LCS)”, eight positioning systems that combine different GPS, cellular and data network technologies. The present invention can use, for example, any combination of these technologies, some of which are detailed below:
Cell-coverage-based positioning.
Round Trip Time (RTTT)-based positioning.
Time Difference of Arrival (TDOA) positioning.
Enhanced Observed Time Difference (E-OTD).
Global Positioning Systems (GPS).
Time of Arrival (TOA) positioning.
Reference Node Based Positioning (RNBP).
Galileo's positioning system.

These positioning systems are known to persons skilled in the art and are therefore not explained in greater detail.

In FIG. 6, as a result of the use of a streaming protocol, such as the RTSP protocol for example, to transmit multimedia content from the file 630 to the network node 410, different network nodes can simultaneously receive from the streaming server 441, different parts of the multimedia content from the file 630. For example, at a specific time, the streaming server can transmit the beginning of the file 630 to a first network node, the part 622 from the file 630 to a second network node, and the multimedia content that the server 440 is receiving in real-time from the node 340 to a third network node.

Each network node that receives multimedia content from the streaming server uses a different streaming session or streaming presentation on the server 441, and this allows each network node to select the part of the file 630 it wishes to display.

In one embodiment of the present invention, the streaming server does not allow a network node to receive the parts of the content 621, 622 etc. if the streaming server has not previously transmitted advertising content AD 610 to the network node.

In another embodiment, the advertising content can take the form of text or images that occupy part of the screen, such as the lower part of the screen, and the control application 444 inserts the advertising content into part of the multimedia content video frames that the node 340 is transmitting, for example in the lower part of the video.

This type of advertising in the form of text or images that occupy part of the screen of the multimedia player 413 is especially suitable when the network node 410 is receiving from the server 440 in real-time, the multimedia content being transmitted in real-time by the network node 340.

In another embodiment of the present invention, the network node 340 can have assigned an URI, for example a SIP URI assigned by the SIP Proxy 446, which the node 340 uses as the destination SIP URI for transmitting the multimedia content it captures using its camera 343 to the server 440 .

This allows the server 440 to determine that the multimedia content received in the SIP URI originates from the network node 340, and to establish a remuneration for the user of the node 340 transmitting the multimedia content to the server 440. This remuneration can consist of, for example, a percentage of the advertising revenue that the server 440 receives for the ads it inserts into the multimedia content that it receives from the node 340 when it transmits this multimedia content together with advertising content.

Thus, for example, the user of the node 340 can register on the server 440, using a web page from the web server 443 and obtaining a SIP URI that it can use to send multimedia content to the server 440.

Another advantage of the present invention is that it makes it possible to provide advertising that is much more geographically segmented than is allowed by the current state of the art.

The current state of the art allows geographic segmentation of online advertising using, for example, the IP address of the device to which the advertising is transmitted, since this IP address determines in which approximate geographic zone the device is located.

However, this geographic positioning system using IP addresses is only applicable to broad geographic zones, for example, with a radius of 20 kilometers, since many Internet access providers assign IP addresses dynamically and the IP address of a device may change each time it is connected to the Internet.

The present invention allows advertisers to segment their advertising geographically with a precision of a few meters depending on the positioning system used by the node 340 that transmits the multimedia content with geotagging in the form of coordinates.

For example, an advertiser can choose to insert its ads in multimedia content recorded in a very limited geographic area, such as a soccer stadium, a Formula One racetrack or a university campus. In this way, advertisers can target their ads at users who are interested in very specific multimedia content.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

What is claimed is:

1. A method comprising:
establishing a multimedia communication in real-time with a first network node in a data network using an IP-based communications management protocol,
receiving from the first network node a multimedia content that includes geotagging data in the form of geographic coordinates,
determining from the geographic coordinates that the multimedia content is associated with an event,
selecting an advertising content based on the event to create a multimedia file that contains and at least a part of the multimedia content and also the advertising content; and
transmitting at least a part of the multimedia file to a second network node in the data network.

2. A method according to claim 1, wherein the advertising content is received from a third network node in the data network.

3. A method according to claim 2, wherein the third network node is an advertising server.

4. A method according to claim 1, wherein the establishing, receiving, determining, selecting and transmitting processes are performed within a single server.

5. A method according to claim 4, wherein the advertising content is received from a database of the server.

6. A method according to claim 1, wherein transmitting at least a portion of the multimedia file to the second network node occurs simultaneous to receiving the multimedia content from the first network node.

7. A method according to claim 1, wherein the multimedia content is received in real-time from the first network node and transmitted in real-time to the second network node.

8. A method according to claim 1, further comprising a fourth network node and wherein the multimedia file comprises a first part and a second part, the first part of the multimedia file being transmitted to the second network node simultaneous to the second part of the multimedia file being transmitted to the fourth network node.

9. A method according to claim 1, further comprising determining the time at which the multimedia content received from the first network node has been captured by means of data or metadata that the first network node transmits together with the multimedia content.

10. A method according to claim 1, further comprising determining the time at which the multimedia content received from the first network node has been captured based on the time at which the multimedia content is received.

11. A method according to claim 1, wherein at least a part of the multimedia file is transmitted to the third node using a streaming protocol.

12. A method according to claim 11 wherein the streaming protocol is the RTSP protocol.

13. A method according to claim 1, wherein the IP-based communications management protocol is the SIP protocol.

14. A method according to claim 1, wherein the multimedia content is received from the first node using the RTP protocol.

15. A method according to claim 1, wherein a control application reads the multimedia content and the advertising content to create a virtual file that is transmitted to the second network node.

16. A method comprising:
establishing a multimedia communication in real-time with a first network node in a data network using an IP-based communications management protocol,
receiving from the first network node a multimedia content, and determining from data of the multimedia content the geographic coordinates of the first network node,
determining from the geographic coordinates that the multimedia content is associated with an event,
selecting an advertising content based on the event to create a multimedia file that contains and at least a part of the multimedia content and also the advertising content; and
transmitting at least a part of the multimedia file to a second network node in the data network.

17. A method according to claim 16, wherein all of the establishing, receiving, determining, selecting and transmitting processes are performed within a single server.

18. A method according to claim 16 wherein the data of the multimedia content used for determining the geographic coordinates of the first network node is an IP address of the network node.

19. A method according to claim 16, wherein the advertising content is received from a third network node in the data network.

20. A method according to claim 19, wherein the third network node is an advertising server.

21. A method according to claim 17, wherein the advertising content is received from a database of the server.

22. A method according to claim 16, wherein transmitting at least a portion of the multimedia file to the second network node occurs simultaneous to receiving the multimedia content from the first network node.

23. A method according to claim 16, wherein the multimedia content is received in real-time from the first network node and transmitted in real-time to the second network node.

24. A method according to claim 16, further comprising a fourth network node and wherein the multimedia file comprises a first part and a second part, the first part of the multimedia file being transmitted to the second network node simultaneous to the second part of the multimedia file being transmitted to the fourth network node.

25. A method according to claim 16, further comprising determining the time at which the multimedia content received from the first network node has been captured by means of data or metadata that the first network node transmits together with the multimedia content.

26. A method according to claim 16, further comprising determining the time at which the multimedia content received from the first network node has been captured based on the time at which the multimedia content is received.

27. A method according to claim 16, wherein at least a part of the multimedia file is transmitted to the third node using a streaming protocol.

28. A method according to claim 27 wherein the streaming protocol is the RTSP protocol.

29. A method according to claim 16, wherein the IP-based communications management protocol is the SIP protocol.

30. A method according to claim 16, wherein the multimedia content is received from the first node using the RTP protocol.

31. A method according to claim 16, wherein a control application reads the multimedia content and the advertising content to create a virtual file that is transmitted to the second network node.

32. A server in a data network comprising one or more components that function to receive multimedia content in the form of IP packets from a first network node and to combine advertising content with at least a portion of the multimedia content to produce a multimedia file to be transmitted to a second network node, the one or more components of the server comprising hardware and/or software to perform the functions of (1) establishing a multimedia communication in real-time with the first network node using an IP-based communications management protocol, (2) receiving from the first network node the multimedia content that includes geotagging data in the form of geographic coordinates, (3) determining from the geographic coordinates that the multimedia content is associated with an event, (4) selecting the advertising content based on the event to create the multimedia file; and (5) transmitting at least a part of the multimedia file to a second network node in the data network.

33. A server according to claim 32, wherein the advertising content is received from a storage medium located within the server.

34. A server according to claim 32, wherein the server is configured to receive the advertising content from a third network node in the data network.

35. A server according to claim 32, wherein the server is configured to determine the time at which the multimedia content received from the first network node has been captured by means of data or metadata that the first network node transmits together with the multimedia content.

36. A server according to claim 32, wherein the server is configured to determine the time at which the multimedia content received from the first network node has been captured based on the time at which the multimedia content is received.

37. A server according to claim 32, wherein the server is configured to transmit at least a part of the multimedia file to the third node using a streaming protocol.

38. A server according to claim 37 wherein the streaming protocol is the RTSP protocol.

39. A server according to claim 32, wherein the IP-based communications management protocol is the SIP protocol.

40. A server according to claim 32, wherein the server comprises a control application that reads the multimedia content and the advertising content to create a virtual file that the server transmits to the second network node.
